(19) United States
(12) Patent Application Publication
(10) Pub. No.: US 2017/0212881 A1
(43) Pub. Date: Jul. 27, 2017

(54) SYSTEMS AND METHODS FOR SIMPLIFYING A CHECK TESTING DATA INTERFACE

(71) Applicant: Bank of America Corporation, Charlotte, NC (US)

(72) Inventors: Karin Wiles, San Antonio, TX (US); Meka L. Carroll, Jacksonville, FL (US); Mary E. Hudgins, Richmond, VA (US); Charles C. Harbinson, Charlotte, NC (US); Erin K. Cassell, Charlotte, NC (US); Nilesh Gadge, Charlotte, NC (US); Linda L. Marsh, Richmond, VA (US)

(21) Appl. No.: 15/006,367

(22) Filed: Jan. 26, 2016

(51) Int. Cl. G06F 17/24; G06F 17/21; G06F 17/22; G06F 3/0482

(52) U.S. Cl. CPC G06F 17/245; G06F 3/0482; G06F 17/218; G06F 17/2247; G06F 17/247

(57) ABSTRACT

A four-quadrant graphical user interface apparatus is provided. The apparatus may present an upper left quadrant which may display either a check date text entry field configured to receive data related to the date of check or an image DPI text entry field configured to receive data related to the DPI of the check image. When the upper left quadrant displays a check data text entry field, the upper right quadrant may display an image DPI text entry field. When the upper left quadrant displays an image DPI text entry field, the upper right quadrant may display a check data text entry field. Check image option selection information may cause the selected information to be displayed, preferably in real time, on the actual check image in the lower right quadrant.

### FIELD OF TECHNOLOGY

This invention relates to interfaces in a check testing environment. More specifically the invention relates to simplifying the interfaces in a check testing environment.

### BACKGROUND OF THE DISCLOSURE

Conventional interfaces in a check testing environment may be complex and cumbersome. The task configuring data required for creating check records in a check testing environment allows mistakes and inaccuracy.

In addition, the required data creation may be time-consuming and therefore costly, which may make the current system a sub-optimal system.

Therefore, it would be desirable to simplify the data entry interface in a check testing environment. The simplification may reduce the number of fields required in creating check records.

Furthermore, it would be desirable for the system to set the various fields that do not require user data entry, to a default value, thereby simplifying and shortening the process for creating check records for use in a check testing environment.

### SUMMARY OF THE INVENTION

Interfaces, according to some embodiments, may be configured to accept user input relating to a first subset of user configurable entry fields. Such entry fields may be selected from a larger plurality of entry fields.

The first subset of user configurable entry fields may include a check image date text entry field. The check image date text entry field may accept user input relating to a date of a check.

The first subset of user configurable entry fields may also include a check image DPI (dots per inch) text entry field. The check image DPI text entry field may accept user input relating to a DPI of the image of the check.

The first subset of user configurable entry fields may also include an encode magnetic ink character recognition (“MICR”) line on generated check checkbox. The MICR line on generated check checkbox may be configured, when selected, to transmit an electronic instruction to encode MICR line information on the check.

The first subset of user configurable entry fields may also include a draw courtesy amounts on generated check checkbox. The draw courtesy amounts on generated check checkbox may be configured, when selected, to transmit a second electronic instruction to draw courtesy amount information on the check. Courtesy amount information is information that reflects the value of the check and is written in numeric form on the face of the check.

The first subset of user configurable entry fields may also include an encode MICR line amounts on generated check checkbox. The encode MICR line amounts on generated check checkbox may be configured, when selected, to transmit a third electronic instruction to encode MICR line amounts information on the check.

The first subset of user configurable entry fields may also include a draw legal amounts on generated check checkbox. The draw legal amounts on generated check checkbox may be configured, when selected, to transmit a fourth electronic instruction to draw legal amounts information on the check.

The method may further include defining a second subset of entry fields. The second subset may include the plurality of entry fields excluding the first subset of entry fields. The second subset may include numerous entry fields.

The method may further include setting each entry field from the second subset of numerous entry fields to a non-user-configurable default value and a concealment attribute.

Furthermore, the method may include tagging each of the entry fields set to the non-user configurable default value, with a concealment tag such that a user can not view those fields. This setting enables the user to experience a more simplified method for creating check records to be used in the check testing environment.

The method may further include enabling the second subset of entry fields to be user configurable upon entry of a password.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a conventional illustrative web page.

FIG. 2 shows an illustrative flow chart according to certain embodiments.

FIG. 3 shows an illustrative web page which enables a user to enter and/or edit check data.

FIG. 4 shows an illustrative web page which enables a user to select one or more files to import data.

FIG. 5 shows an illustrative web page which enables a user to make selections and generate x9 data for a check. X9 data may relate to data for use with certain types of electronic processing.

FIG. 6 shows a check image for use with data.

### DETAILED DESCRIPTION OF THE DISCLOSURE

Some embodiments involve a method for providing a graphical user interface in a check testing environment. Certain embodiments may simplify such an interface over conventional interfaces.

Interfaces according to certain embodiments may provide a text entry field table. The text entry field table may be configured to accept user input relating to a plurality of check records. The check records may be suitable for use in the check testing environment.

The text entry field table may include a record type column. The record type column may accept user input relating to the plurality of check records. The record type column may define each check record to be either a debit or a credit.

The text entry field table may also include an auxiliary serial number column. The auxiliary serial number column may accept user input relating to the plurality of check records. The auxiliary serial number column may define each check record's auxiliary serial number.

The text entry field table may also include an account number column. The account number column may accept user input relating to the plurality of check records. The account number column may define each check record's account number.

The text entry field table may also include an amount column. The amount column may accept user input relating to the plurality of check records. The amount column may define each check record's total amount.

The text entry field table may also include a return reason code column. The return reason code column may accept user input relating to the plurality of check records. The return reason code column may describe, when applicable, the reason for the rejection of the check.

The text entry field table may also include a routing transit number column. The routing transit number column may accept user input relating to the plurality of check records. The routing transit number column may define each check record's routing transit number.

The method may further include inputting data into a check record from the plurality of check records. Upon receipt of the data, the method may search using a check testing system. The searching may identify duplicates of received data. Upon determining that no duplicates exist in the database for the inputted data, the check testing system may be configured to save the data as a check record in the database.

According to some embodiments, the method may provide, on a first graphical user interface, a text entry field table which accepts user input relating to a plurality of check records to be used in the check testing environment.

According to some embodiments, the method may provide, on a second graphical user interface, a text entry field table which accepts user input relating to a plurality of check records to be used in the check testing environment.

Some embodiments involve a four-quadrant graphical user interface.

The apparatus may present an upper left quadrant displaying either a check date text entry field configured to receive data related to the date of the check or an image DPI text entry field configured to receive data related to the DPI of the image of the check.

The apparatus may also present an upper right quadrant displaying either a check date text entry field configured to receive data related to the date of the check or an image DPI text entry field configured to receive data related to the DPI of the image of the check.

The apparatus may further present a lower left quadrant displaying the check-image related options and a lower right quadrant displaying the actual check image.

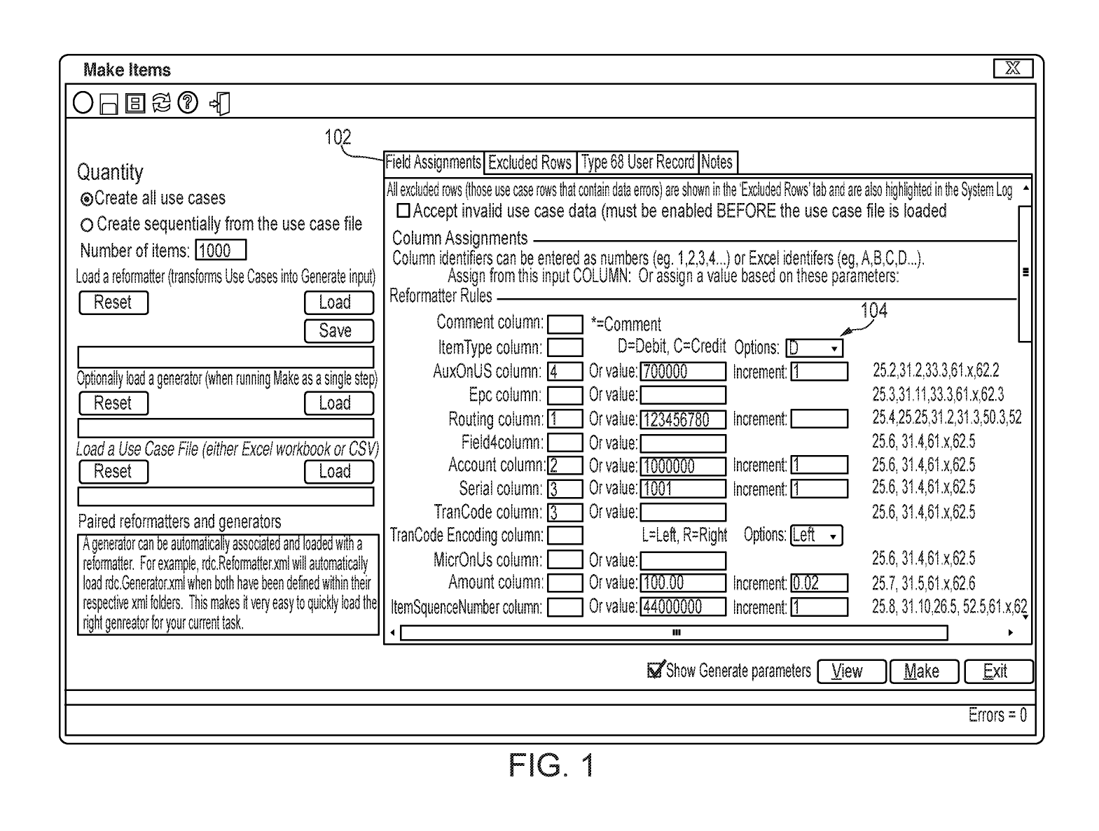

FIG. 1 shows a conventional illustrative web page that is complex and cumbersome. Section 102 shows numerous tabs that are required by the user to analyze and review. Section 104 shows numerous check data text entry fields that require input from the user. The required data creation as shown at 102 and 104 may be time consuming and increases chance of error and inaccuracy.

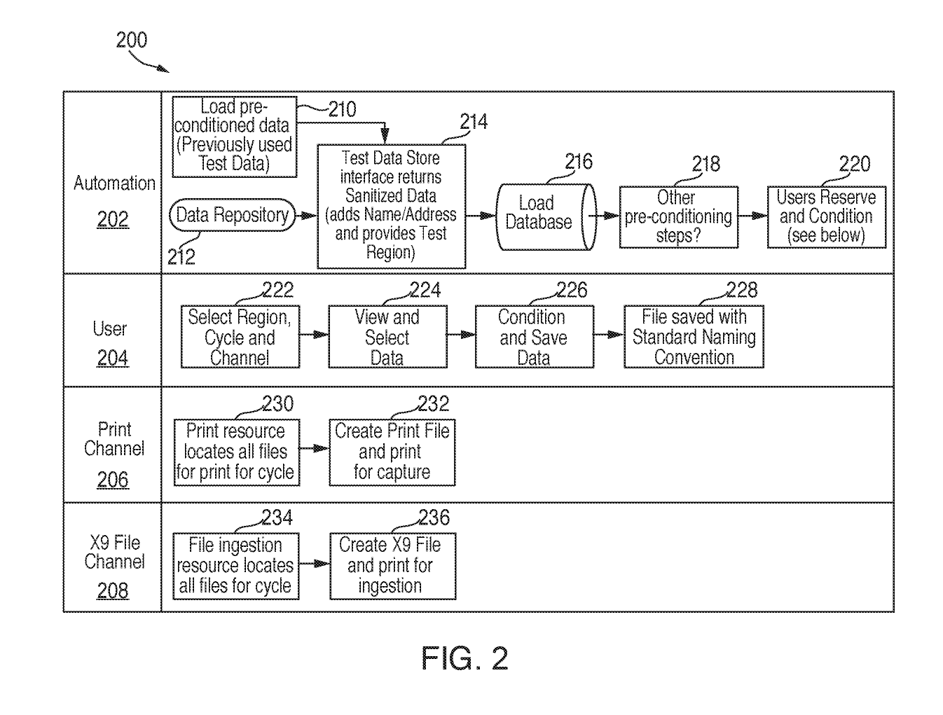

FIG. 2 shows an illustrative flow chart according to certain embodiments. Section 202 shows automation steps of a check testing system. Section 204 shows steps performed by a user. Section 206 shows steps utilizing a print channel. Section 208 shows steps utilizing the x9 file channel.

Step 210 shows loading preferably, previously-used, pre-conditioned test data. The pre-conditioned data is data that has already proven the desired outcome. The previously-used, pre-conditioned test data together with the data repository, shown at 212, may be transmitted to test data store interface 214. Test data store interface 214 may return sanitized data from the received data. The sanitized data may be data with specified fields omitted, enabling the data to be agnostic—i.e., non-traceable to an actual transaction. Test data store interface 214 may add name and/or address information to the data. Test data store interface 214 may also provide test region information for the data. The returned data may be loaded into a database, as shown at 216. The data may require additional pre-conditioned steps, as shown at 218. A user may reserve and/or condition the data when necessary, making it suitable for a specific test scenario, as shown at 220. In one example, conditioning the data 220, may allow the user to change a character thereby enabling the test data to return the data as “invalid.”

The user may select a region and/or cycle as shown at 222. The user may also select a channel for testing as shown at 222. The user may view and select test data as shown at 224. The user may condition the data and save the data into a database as shown at 226. “File saved” with standard naming convention 228 stores the conditioned data 226.

Print resource 230 locates all files saved at 228 for a “print for” cycle. A print file may be created as shown at 232. A “print for” capture may also be created as shown at 232.

File ingestion resource as shown at 234, locates all files for a pre-determined cycle. An x9 file and print for ingestion is now created as shown at 236.

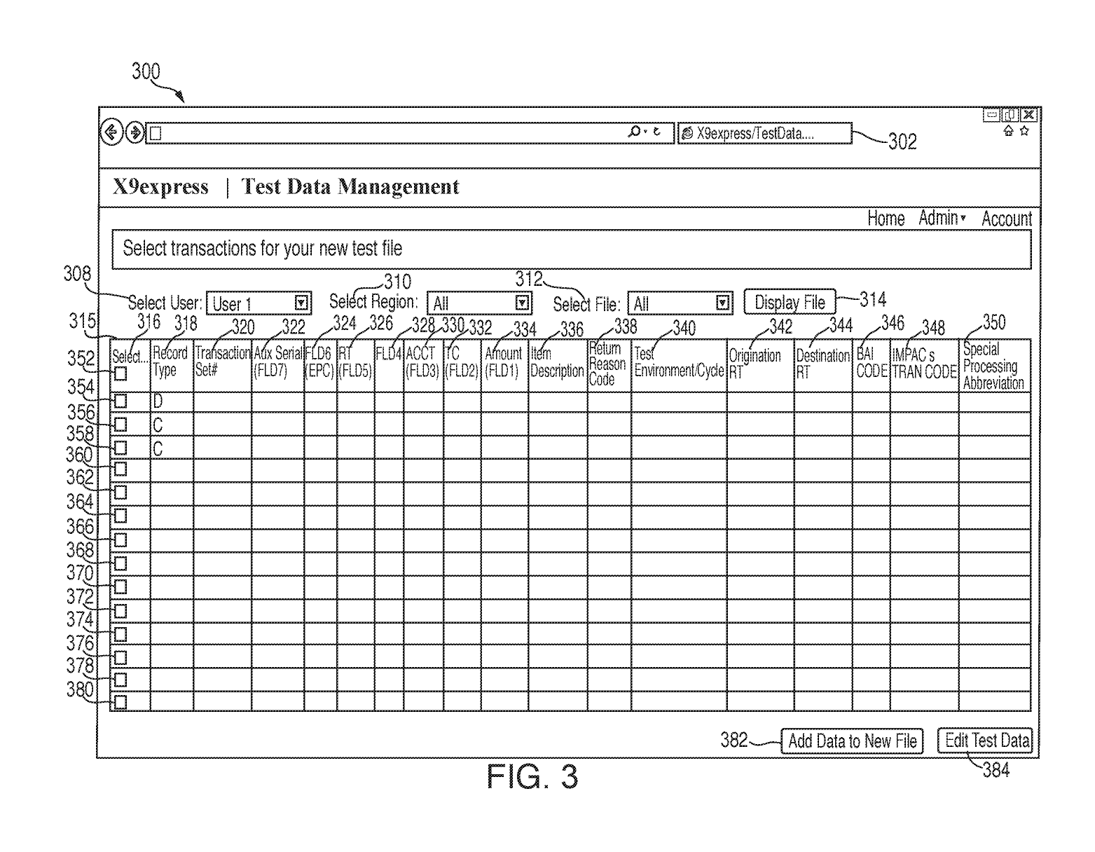

FIG. 3 shows an illustrative web page which enables a user to enter and/or edit check data. Webpage 300 may be opened on an x9 express test data management tab 302. A user may select a user name from a drop-down field as shown at 308. A user may also select a region from a drop-down field as shown at 310. A user may then choose to select a file as shown at 312. Upon selection of a display file button 314, the webpage is configured to display the data stored in the file 312. When a user does not choose to select a file 312, a user may manually enter the data into each cell of the check record data table 315.

The check record data table 315 may include record type column 318 which may enable the user to characterize the data as either a debit type of data or a credit type of data.

Another column may include a transaction set number for a single transaction shown at column 320. A single transaction 320 may include a transaction comprising a single credit and multiple debits. A single transaction 320 may also include multiple credits and a single debit. A single transaction may also include multiple credits and multiple debits.

Another column may include an auxiliary serial column 320 displaying the check number. Another column may include a field six column 324 which may identify a unique application such as a return item, a forward or return substitute check or a remotely printed check. Another column may include a routing column 326 which may display the routing number. Another column may include a field four column 328 which when necessary may be used for specific testing for legacy checks such as a military bank check. Another column may include an account type column 330 which may define the user or test account number. Another column may include a transaction code type column 332 which may define the processing to be either debit type processing or credit type processing. Another column may include an amount type column 334 which may define the dollar amount of the credit or debit. Another column may include an item description type column 336 which may describe the scenario of the test. Another column may include a return reason code type column 338 which may define a return reason for a check.

Another column may include the test environment and/or cycle type column 340 which may define a test region from the three standard test regions where the data may be executed. Furthermore, each test region may be used repeatedly. Test environment and/or cycle may also define the iteration of testing where test data will be executed.

Origination routing number 342 may be another column type which may indicate, the drawing bank, for x937 files. X937 files are files that are processed electronically and may need no printing or capturing of items. The destination routing number 344 may be another column type which may indicate, for x937 files, the drawee bank.

Upon selection of a single checkbox from checkboxes 354-380, or upon selection of a plurality of checkboxes from checkboxes 354-380, the system may enable the user to either edit or save the selection of check records. Upon selection of checkbox 352 and option button 382, the system may be configured to save all the data from the check record data table 315 to a new file. Upon selection of checkbox 352 and option button 384, the system may be configured to enable the user to edit all the previously recorded test data.

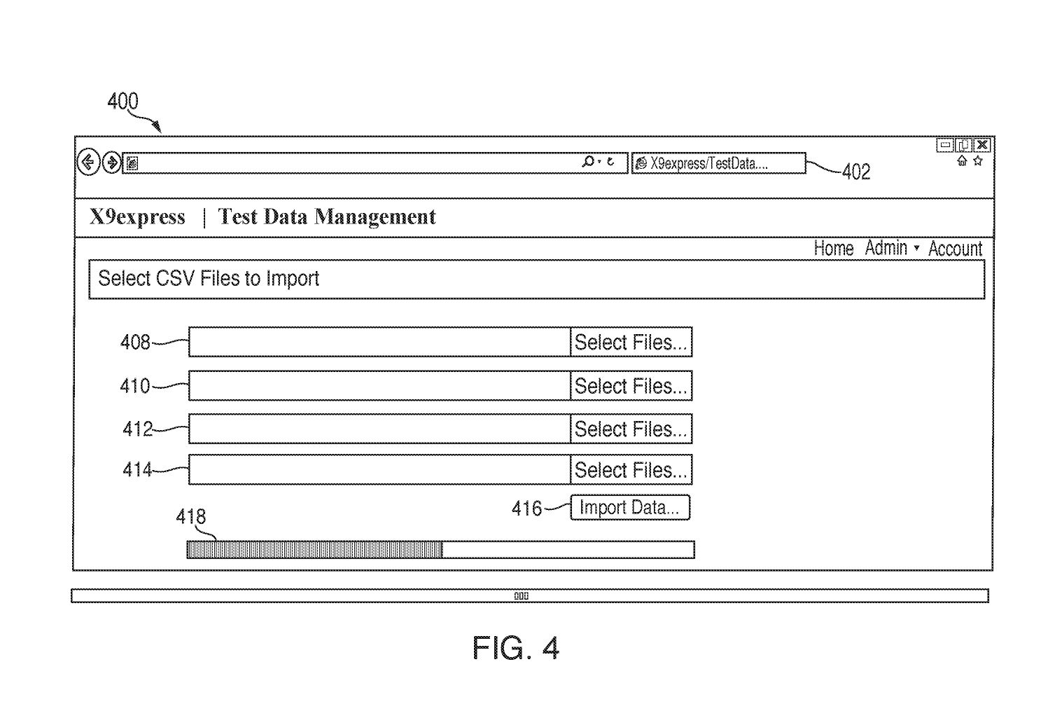

FIG. 4 shows an illustrative web page which enables a user to select one or more files to import data. Webpage 400 may be opened on an express test data management tab 402. The user may select one or more files as shown at 408-414. Upon selection of import data button 416, the webpage 400 may display the files loading progress 418 and is configured to load the files to the x9 express test data management system.

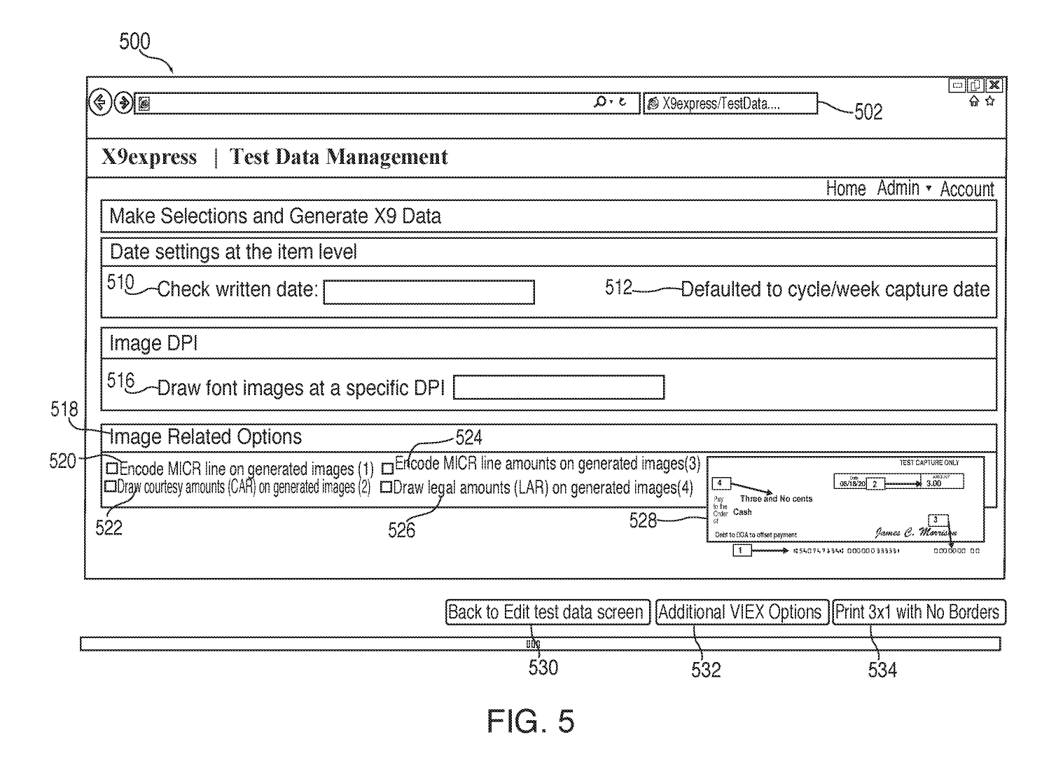

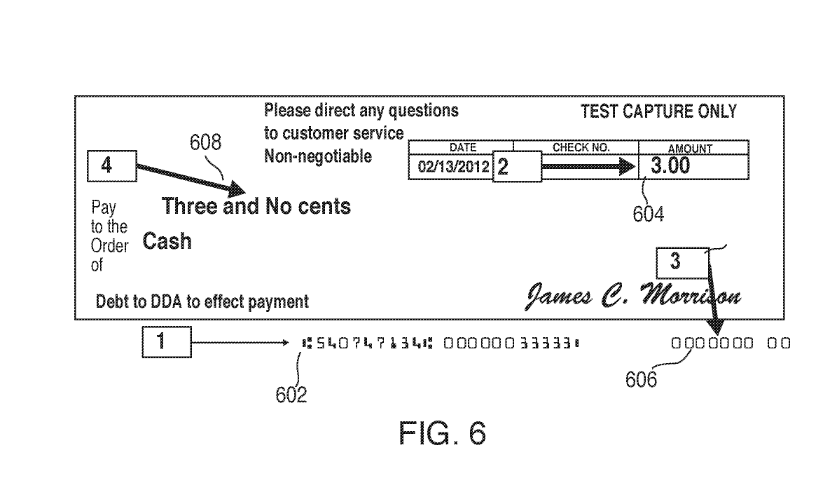

FIG. 5 shows an illustrative web page which enables a user to make selections and generate x9 data for a check. Webpage 500 may be opened on an express test data management tab 502. Check written date field 510 accepts user input relating to the date of the check. Check written date text entry field 510 may be left blank and the date may be defaulted to the cycle or week capture date shown at 512. A draw font images at a specific DPI text entry field 516 accepts user input relating to the DPI of the image of the check. Image related options section 518 may include an encode MICR line on generated images checkbox 520, which when selected, may generate a MICR line 602 on the check. Draw courtesy amounts on generated images checkbox 522, which when selected, may draw the check total amount as shown at 604. Image related options section 518 may also include an encode MICR line amounts on generated images checkbox 524, which when selected, may generate a MICR line amount as shown at 606. Image related options section 518 may also include a draw legal amounts on generated images checkbox 526, which when selected, may draw the legal amount as shown at 608. 528 refers to the check-image. Check-image details are shown at FIG. 6. Option button 530 may enable the user to edit data at test data screen 300. Option button 532 may enable the user to select additional options for an x937 file creation and processing. X937 files are processed electronically and may need no printing or capturing of items. Option button 534 prints the check-image as a 3×1 dimension size with no borders.

Thus, systems and methods for simplifying a check testing data interface is provided. Persons skilled in the art will appreciate that the present invention can be practiced by other than the described embodiments, which are presented for purposes of illustration rather than of limitation, and that the present invention is limited only by the claims that follow.

What is claimed is:

1. A method for simplifying a graphical user interface in a check testing environment, the method comprising:
providing a text entry field table, which accepts user input data relating to a plurality of check records, said check records for use in the check testing environment, the text entry field table comprising;
a record type column, said record type column which accepts user input data relating to the plurality of check records, the record type column that defines each check record to be either a debit or a credit;
an auxiliary serial number column, said auxiliary serial number column which accepts user input data relating to the plurality of check records, the auxiliary serial number column that defines each check records check number;
an account number column, said account number column which accepts user input data relating to the plurality of check records, the account number column that defines each check records account number;
an amount column, said amount column which accepts user input data relating to the plurality of check records, the amount column that defines each check records total amount;
a return reason code column, said return reason code column which accepts user input data relating to the plurality of check records, the return reason code column describing, when applicable, the return reason code for a rejection of the check;
a routing transit number column, said routing transit number column which accepts user input data relating to the plurality of check records, the routing transit number column that defines each check records routing transit number;
inputting the data into a check record from the plurality of check records of the text entry field table;
upon receipt of the data, searching using a check testing system, said searching for identifying duplicates of received data;
upon determining that no duplicates exist in the database for the data, the check testing system is configured to save the data as a check record in the database.

2. The method of claim 1 wherein said user input data is pre-conditioned data, said pre-conditioned data which comprises data that was previously submitted to the check testing system in a check testing environment.

3. The method of claim 2 further comprising sanitizing said pre-conditioned data, said sanitizing comprising, deleting all fields related to traceability of the transaction.

4. The method of claim 3 further comprising conditioning said pre-conditioned and sanitized data, said conditioning comprising providing a platform for altering one or more fields of the data in order to enable deliberately misstating testing data.

5. A method for simplifying a graphical user interface in a check testing environment, the method comprising:
selecting a first subset of user configurable entry fields from a plurality of entry fields, the first subset of user configurable entry fields comprising:
a check image date text entry field, said check image date text entry field which accepts user input relating to a date of a check;
a check image DPI (dots per inch) text entry field, said check image DPI text entry field which accepts user input relating to a DPI of the check;
an encode magnetic ink character recognition (“MICR”) line on generated check checkbox, said MICR line on generated check checkbox which, when selected, transmits an electronic instruction to encode MICR line information on the check;
a draw courtesy amounts on generated check checkbox, said draw courtesy amounts on generated check checkbox which, when selected, transmits a second electronic instruction to draw courtesy amount information on the check;
an encode MICR line amounts on generated check checkbox, said encode MICR line amounts on generated check checkbox which, when selected, transmits a third electronic instruction to encode MICR line amounts information on the check; and
a draw legal amounts on generated check checkbox, said draw legal amounts on generated check checkbox which, when selected, transmits a fourth electronic instruction to draw legal amounts information on the check;
defining a second subset of entry fields, the second subset comprising the plurality of entry fields excluding the first subset of entry fields;
setting each entry field from the second subset of entry fields to:
a non-user-configurable default value; and
a concealment attribute;

6. The method of claim 5 further comprising enabling the second subset of entry fields to be user configurable upon entry of a password.

7. A method for simplifying graphical user interfaces in a check testing environment, the method comprising:
providing, on a first graphical user interface, a text entry field table which accepts user input relating to a plurality of check records to be used in the check testing environment, the text entry field table comprising;
a record type column, which accepts user input relating to the plurality of check records, the record type column defining each check record to be of type debit or credit;
an auxiliary serial number column, which accepts user input relating to the plurality of check records, the auxiliary serial number column defining each check records check number;
an account number column, which accepts user input relating to the plurality of check records, the account number column defining each check records account number;
an amount column, which accepts user input relating to the plurality of check records, the amount column defining each check records total amount;
a return reason code column, which accepts user input relating to the plurality of check records, the return reason code column describing, when applicable, the return reason code for a rejection of the check;
a routing transit number column, which accepts user input relating to the plurality of check records, the routing transit number column defining each check records routing transit number;
inputting data into a check record from the plurality of check records of the text entry field table;
upon submitting the data, a check testing system is configured to search a check testing database for duplicates of the data; wherein:
upon detecting a duplicate, the check testing system is configured to prompt the user with the option to override the legacy check record and save the duplicated check record as the legacy check record; or
upon determining that no duplicates exist in the database for the data, the check testing system is configured to save the data as a check record in the database;
selecting a first subset of user configurable entry fields from a plurality of entry fields, the first subset of user configurable entry fields comprising:
a check image date text entry field, which accepts user input relating to a date of a check record;
a check image DPI (dots per inch) text entry field, which accepts user input relating to a DPI of the image of the check record;
an encode magnetic ink character recognition (“MICR”) line on generated check checkbox, which when selected transmits an electronic instruction to encode MICR line information on the check record;
a draw courtesy amounts on generated check checkbox, which when selected transmits a second electronic instruction to draw courtesy amount information on the check record;
an encode MICR line amounts on generated check checkbox, which when selected transmits a third electronic instruction to encode MICR line amounts information on the check record; and
a draw legal amounts on generated check checkbox, which when selected transmits a fourth electronic instruction to draw legal amounts information on the check record;
defining a second subset of entry fields, the second subset comprising the plurality of entry fields excluding the first subset of entry fields;
setting each entry field from the second subset of entry fields to:
a non user configurable default value; and
a hidden attribute; and
displaying the first subset of user configurable entry fields on a second graphical user interface.

8. The method of claim 7, wherein, for the check record, a user inputs the date into the check image date text entry field.

9. The method of claim 7, wherein, for the check record, the user inputs the DPI into the check image DPI text entry field.

10. The method of claim 7, wherein:
for the check record, the user selects the MICR line generated check checkbox;
in response to the user selecting the MICR line generated check checkbox, the check testing system is configured to generate a MICR line on a generated check associated with the check record.

11. The method of claim 7, wherein:
for the check record, the user selects the draw courtesy amounts generated check checkbox;
in response to the user selecting the draw courtesy amounts generated check checkbox, the check testing system is configured to draw the courtesy amount on the generated check.

12. The method of claim 7, wherein:
for the check record, the user selects the draw MICR line amounts generated check checkbox;
in response to the user selecting the draw MICR line amounts generated check checkbox, the check testing system is configured to draw the MICR line amount on the generated check.

13. The method of claim 7, wherein:
for the check record, the user selects the draw legal amounts generated check checkbox;
in response to the user selecting the draw legal amounts generated check checkbox, the check testing system is configured to draw the legal amount on the generated check.

14. A four-quadrant graphical user interface apparatus comprising:
an upper left quadrant displaying either a check date text entry field configured to receive data related to the date of the check or an image DPI text entry field configured to receive data related to the DPI of the image of the check;
when the upper left quadrant displays a check data text entry field, the upper right quadrant displays an image DPI text entry field;
when the upper left quadrant displays an image DPI text entry field, the upper right quadrant displays a check data text entry field;
a lower left quadrant displaying check image related options; and
a lower right quadrant displaying the actual check image.

15. The system of claim 14, wherein, said check image option selection information is configured to be displayed, in real time, on the actual check image in the lower right quadrant.

16. The apparatus of claim 14 further providing a check image related option comprising an encode MICR line on generated check checkbox. Said MICR line on generated check checkbox which, when selected, transmits an electronic instruction to encode MICR line information on the check.

17. The apparatus of claim 14 further providing a second check image related option comprising a draw courtesy amounts on generated check checkbox. Said draw courtesy amounts on generated check checkbox which, when selected, transmits a second electronic instruction to draw courtesy amount information on the check.

18. The apparatus of claim 14 further providing a third check image related option comprising an encode MICR line amounts on generated check checkbox. Said encode MICR line amounts on generated check checkbox which, when selected, transmits a third electronic instruction to encode MICR line amounts information on the check.

19. The apparatus of claim 14 further providing a third check image related option comprising a draw legal amounts on generated check checkbox. Said draw legal amounts on generated check checkbox which, when selected, transmits a fourth electronic instruction to draw legal amounts information on the check.
